(19) United States
(12) Patent Application Publication
(10) Pub. No.: US 2015/0188867 A1
(43) Pub. Date: Jul. 2, 2015

(54) ELECTRONIC DEVICE AND METHOD FOR CONTROLLING TARGET DEVICE

(71) Applicant: Samsung Electronics Co., Ltd,, Suwon-si (KR)

(72) Inventors: Jun-Chul LEE, Suwon-si (KR); Sun-Yong KIM, Seoul (KR); Hyun-Joon KIM, Seoul (KR); Young SON, Yongin-si (KR)

(21) Appl. No.: 14/570,246

(22) Filed: Dec. 15, 2014

(30) Foreign Application Priority Data
Dec. 27, 2013 (KR) 10-2013-0165796

(51) Int. Cl. H04L 12/58

(52) U.S. Cl. CPC H04L 51/18; H04L 51/32; H04L 51/04

(57) ABSTRACT

An electronic device and method for collectively controlling target devices are provided. The electronic device includes a communication unit configured to communicate data, and a processor configured to initiate a group conversation to control at least one target device, and, upon reception of a control command to control a function of the at least one target device, to transmit the control command to the at least one target device through the group conversation.

### CROSS-REFERENCE TO RELATED APPLICATION(S)

This application claims the benefit under 35 U.S.C. §119(a) of a Korean patent application filed on Dec. 27, 2013 in the Korean Intellectual Property Office and assigned Serial No. 10-2013-0165796, the entire disclosure of which is incorporated hereby incorporated by reference.

### TECHNICAL FIELD

The present disclosure relates to an electronic device and method for collectively controlling at least one target device, such as a television, a washing machine, an air conditioner, a door-lock system, and the like, using an instant message.

### BACKGROUND

A home automation system automates management of many different target devices at home, such as televisions, washing machines, air conditioners, door-lock systems, thermostats, and the like, by automatically controlling them.

The home automation system stores information about many target devices, and includes a control device for transmitting a pre-stored control signal to each target device at a user's request and multiple target devices for receiving the control signal and performing functions according to the control signal. Each target device may also be equipped with a corresponding control device and perform a function under control of the control device.

For example, upon reception of a request to control a first target device from a user device, the control device controls the first target device to perform a function of the first target device. The first target device, upon reception of the control signal, performs the requested function and transmits the result of performing the function to the control device. The control device transmits the result to the user device.

As such, the user device traditionally delivers a control signal to a target device, and the target device performs a function according to the control signal.

However, it is inconvenient for the user to make connections with many different kinds of target devices to control them, and to use techniques dedicated to the target devices to control them.

In addition, in order for the user device to control multiple target devices, the user device has to install a corresponding number of programs for each of the target devices and control them separately.

Accordingly, an electronic device and method for collectively controlling at least one target device using an instant message is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an electronic device and method for collectively controlling at least one target device using an instant message.

In accordance with an aspect of the present disclosure, an electronic device is provided. The electronic device includes a communication unit configured to communicate data, and a processor configured to initiate a group conversation to control at least one target device, and, upon reception of a control command to control a function of the at least one target device, to transmit the control command to the at least one target device through the group conversation.

In accordance with another aspect of the present disclosure, a method is provided. The method includes initiating a group conversation to control at least one target device, receiving a control command to control a function of the at least one target device, and transmitting the control command to the at least one target device through the group conversation.

Other aspects, advantages, and salient features of the disclosure will become apparent to those skilled in the art from the following detailed description, which, taken in conjunction with the annexed drawings, discloses various embodiments of the present disclosure

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram of an integrated control system according to an embodiment of the present disclosure;

FIG. 2 is a schematic diagram of an integrated control system according to another embodiment of the present disclosure;

FIG. 3 is a block diagram of an electronic device according to an embodiment of the present disclosure;

FIG. 4 is a flowchart illustrating a procedure of controlling target devices through a group conversation in an electronic device according to an embodiment of the present disclosure;

FIGS. 5 and 6 are a detailed flowchart illustrating a procedure of controlling target devices through a group conversation in an electronic device according to an embodiment of the present disclosure;

FIG. 7 is a flowchart illustrating a procedure of controlling target devices in an integrated control system according to an embodiment of the present disclosure;

FIG. 8 is a flowchart illustrating a procedure of controlling target devices in an integrated control system according to another embodiment of the present disclosure;

FIGS. 9A, 9B, and 9C illustrate screen images showing a procedure of adding a new target device onto a target device list according to an embodiment of the present disclosure;

FIGS. 10A and 10B illustrate screen images of a first electronic device that initiates a group conversation and displays detailed information and usable functions of target devices according to an embodiment of the present disclosure;

FIGS. 11A and 11B illustrate screen images of a second electronic device that participates in a group conversation and displays detailed information and usable functions of target devices according to an embodiment of the present disclosure;

FIGS. 12A and 12B illustrate screen images showing a procedure of controlling target devices through a group conversation according to an embodiment of the present disclosure;

FIGS. 13A, 13B, and 13C illustrate screen images showing how to add a new user into a group conversation and to set a right of the new user according to an embodiment of the present disclosure;

FIGS. 14A and 14B illustrate screen images showing how to add a new function of a target device according to an embodiment of the present disclosure; and

FIGS. 15A and 15B illustrate setting screens for a target device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural references unless the context clearly dictates otherwise. Thus, for example, reference to “a component surface” includes reference to one or more of such surfaces.

An electronic device may be any device that has a display unit, and be referred to as a portable device, mobile terminal, communication terminal, portable communication terminal, portable mobile terminal, and the like.

For example, the electronic device may be a smart phone, a cell phone, a game console, a television, a display device, a vehicle head unit, a notebook computer, a laptop, a tablet Personal Computer (PC), a Personal Media Player (PMP), a Personal Digital Assistant (PDA), a wearable device or the like. The electronic device may be implemented as a pocket-sized portable communication terminal that has a wireless communication function. Further, the electronic device may be a flexible display device. Of course, any other device that is equipped with at least one image sensor may also be used to perform embodiments of the present disclosure. The electronic device may also include a device for virtual space.

In various embodiments of the present disclosure, a portable device will be taken as a representative example of the electronic device, and some components of the portable device may be omitted or replaced if necessary. The various embodiments of the electronic device may be implemented in hardware, software, or a combination of hardware and software.

Target devices used herein may be communicatively coupled to the electronic device and controlled by the electronic device, such as televisions, air conditioners, washing machines, refrigerators, thermostats, door-lock systems, or the like. There may be a separate control device to control target devices to perform functions of the target devices. Alternatively, the target device may include its own control unit to perform a function based on a control command received from the electronic device.

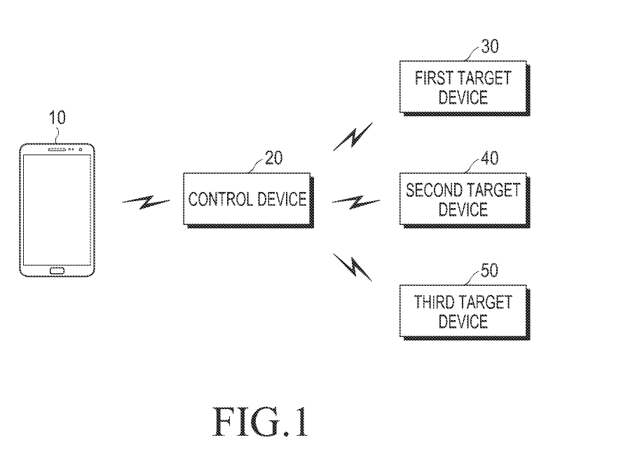

FIG. 1 is a schematic diagram of an integrated control system according to an embodiment of the present disclosure.

Referring to FIG. 1, the integrated control system may include an electronic device 10, a control device 20, a first target device 30, a second target device 40, and a third target device 50. Although this embodiment takes three target devices as an example, the number of target devices is not limited thereto. In the embodiment, assume that the control device 20 for receiving a control command and transmitting a control signal corresponding to the control command is a standalone device.

The electronic device 10 may register the first, second and third target devices 30, 40, and 50 in a conversation target list for group conversation (or group chat) through a social network service based application, and initiate group conversation with the registered target devices 30, 40, and 50 by selecting them. Alternatively, the electronic device 10 may initiate group conversation with target devices 30, 40, and 50 using instant messages.

In registering target devices in the conversation target list, the electronic device 10 may receive target device information, such as a name and ID of each target device, information about functions of the target device, and the like. The electronic device 10 may also detect the target device information automatically through e.g., Near Field Communication (NFC) and store the detected target device information in the memory 130.

When a control command for the first target device 30 is entered, the electronic device 10 may transmit the control command to the control device 20, which in turn transmit the first target device 30 a control signal based on the control command. The first target device 30 may perform a function corresponding to the control signal and transmit the control device 20 a response including a result of performing the function. The control device 20 may transmit the result of performing the function to the electronic device 10, which in turn displays the result on its screen.

The control device 20 may receive and store status information about the first, second, and/or third target devices 30, 40, and/or 50, and transmit the electronic device 10 a notification message indicating the respective status of the first, second, and/or third target devices 30, 40, and/or 50 to the electronic device 10.

Upon reception of the notification message from the control device 20, the electronic device 10 may display the notification message to allow the user to recognize the status of the target device and thus control the target device.

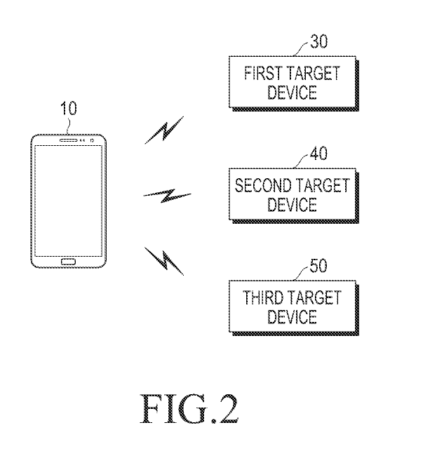

FIG. 2 is a schematic diagram of an integrated control system according to another embodiment of the present disclosure.

Referring to FIG. 2, the integrated control system may include the electronic device 10, the first target device 30, the second target device 40, and/or the third target device 50. In this embodiment, it is assumed that each target device includes its own control device.

The electronic device 10 may initiate group conversation by selecting the first, second, and/or third target devices 30, 40, and/or 50 from a conversation target list for group conversation.

When a control command to control the first target device 30 is entered, the electronic device 10 may transmit the control command to the first target device 30. The first target device 30 may perform a function corresponding to the control command and transmit the electronic device 10 a result of performing the function. The electronic device 10 may display the result on its screen.

At least one of the first, second, and/or third target devices 30, 40, and/or 50 may transmit the electronic device 10 a notification message indicating the status of the target device.

Upon reception of the notification message from the at least one of the first, second, and/or third target devices 30, 40, and/or 50, the electronic device 10 may display the notification message on its screen to allow the user to recognize the status of the target device and control the target device.

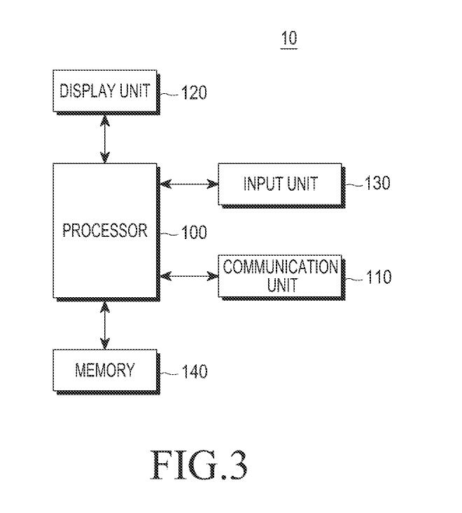

FIG. 3 illustrates a block diagram of the electronic device according to an embodiment of the present disclosure.

Referring to FIG. 3, an electronic device 10 may include a processor 100, a communication unit 110, a display device 120, an input unit 130, and a memory 140, but is not limited thereto.

The processor 100 controls general operations of the electronic device 10, and in particular, adds a requested target device to a conversation target list for group conversation upon request.

If at least one target device is selected for group conversation, the processor 100 may initiate group conversation for the at least one target device. For example, the processor 100 may create a group conversation screen for the selected at least one target device and display the group conversation screen in the display unit 120.

When a control command to control at least one target device is entered, the processor 100 may transmit the control command to the at least one target device.

For example, when a control command is entered through the display unit 120, the processor 100 may display the control command on the group conversation screen while transmitting the control command to the at least one target device. The processor 100 may also control the at least one target device joining the group conversation with a single control command without designating the target device. The at least one target device, upon reception of the control command, may perform a function corresponding to the control command simultaneously or sequentially.

The control command may be a word preset between the electronic device and the target device. For example, if the target device is a refrigerator, the control command may be a text, e.g., “turn off refrigerator”. In another example, the control command may be a conversational style text, for example, “Refrigerator, turn yourself off”. Accordingly, the target device, e.g., the refrigerator in this example, may recognize some words like “refrigerator”, “turn”, “off” as a command to turn it off, and thus perform its power off function.

With a control command “turn off”, at least one target device joining a group conversation may recognize the control command and accordingly turn itself off.

Upon reception of a response to the control command from the at least one target device, the processor 100 may display the response in the display unit 120. The response may include a result of the target device performing the function corresponding to the control command. For example, the response may be a text, e.g., “Refrigerator has been turned off”. While this embodiment illustrates text being displayed as a response, other embodiments may output a voice saying e.g., “refrigerator has been turned off”.

The processor 100 may add other electronic device than the at least one target device to the group conversation, and set a limited right for the added electronic device to control the target device.

For example, upon request, the processor 100 may display a conversation target list of conversation targets addable to the group conversation in the display unit 120.

If a second electronic device is selected from the conversation target list, the processor 100 may display a new group conversation screen in the display unit 120, with the second electronic device participating in the new group conversation.

The processor 100 may display a right setting screen in the display unit 120 to set a right for the second electronic device to control the target device. The right setting screen may be displayed in the display unit 120 upon request or according to any other means.

Upon reception of a notification message from at least one target device, the processor 100 may also display the notification message on the group conversation screen. For example, if receiving a text like “Air conditioner has been turned on for 3 hours. Shall we turn it off?”, the processor 100 may display the text on the group conversation screen.

As such, enabling a target device to transmit a notification message that indicates the target device's status allows the user to recognize the status of the target device and thus control the target device.

The communication unit 110 may perform communication with target devices using various communication techniques. Various communication techniques may include cellular network communications, such as 3G/4G, wireless local area network communications, Bluetooth, infrared data association, WiFi-Direct communications, NFC, and the like.

The display unit 120 may be formed of a Liquid Crystal Display (LCD) and visually provide menus of the electronic device 10, input data, functional setting information and different other information to the user. The display unit 120 may include various devices other than the LCD device. The display unit 120 performs outputting the electronic device's boot screen, standby screen, display screen, call screen, and other application-run screen. The display unit 120 may be a touch screen unit for receiving touch inputs and displaying corresponding outputs.

The memory 140 may store input/output signals or data resulting from operations of the processor 100, the communication unit 110, the display unit 120, and the input unit 130. The memory 140 may also store applications and control programs for controlling the electronic device 10, specifically the processor 100.

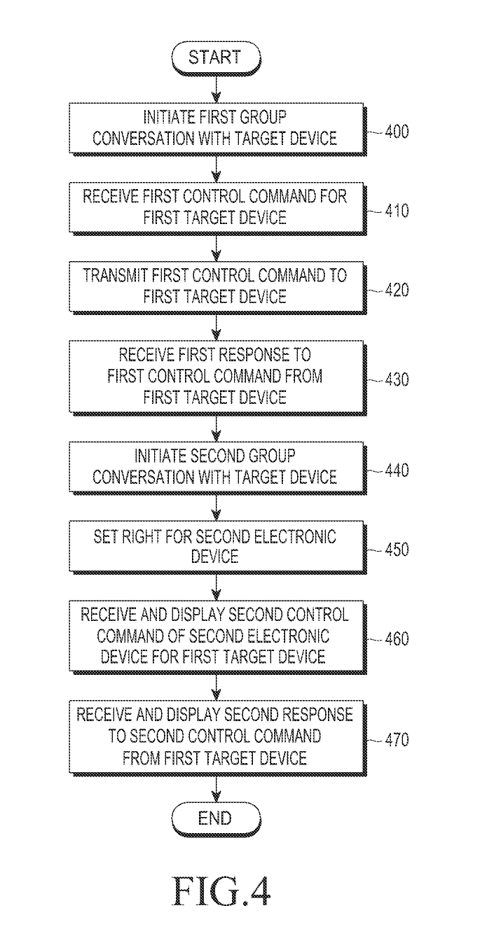

FIG. 4 is a flowchart illustrating a procedure of controlling target devices through a group conversation in the electronic device 10 according to an embodiment of the present disclosure.

Referring to FIG. 4, in operation 400, the processor 100 initiates a first group conversation with at least one target device. For example, the processor 100 may select at least one target device to control them, create a group conversation screen for the selected at least one target device, and display the group conversation screen in the display unit 120.

In operation 410, the processor 100 receives a first control command for a first target device, and in operation 420, transmits the first command to the first target device.

In operation 430, the processor 100 may receive a first response to the first control command from the first target device. The processor 100 may display the received first response in the display unit 120.

In operation 440, the processor 100 initiates a second group conversation with at least one target device and a second electronic device. For example, if there is a selection of the second electronic device to join the first group conversation, the processor 100 may create and display a second group conversation screen with the second electronic device in the display unit 120.

In operation 450, the processor 100 may set a right for the second electronic device that has just joined the second group conversation. Specifically, the processor 100 may provide a control right setting screen to set a limited control right for the second electronic device to control at least one target device joining the second group conversation. For example, with the control right setting screen, controlling functions of each target device may be enabled or disabled.

In operation 460, upon reception of a second control command for the second electronic device to control the first target device, the processor 100 may display the second control command in the display unit 120. In other words, the processor 100 may receive the second control command, which is broadcast to those joining the group conversation from the second electronic device. The second command may be displayed on the group conversation screen.

In operation 470, upon reception of a second response to the second control command from the first target device, the processor 100 may display the second response in the display unit 120. In this regard, the first target device may perform a function corresponding to the second control command and broadcast the second response including a result of performing the function to those joining the group conversation.

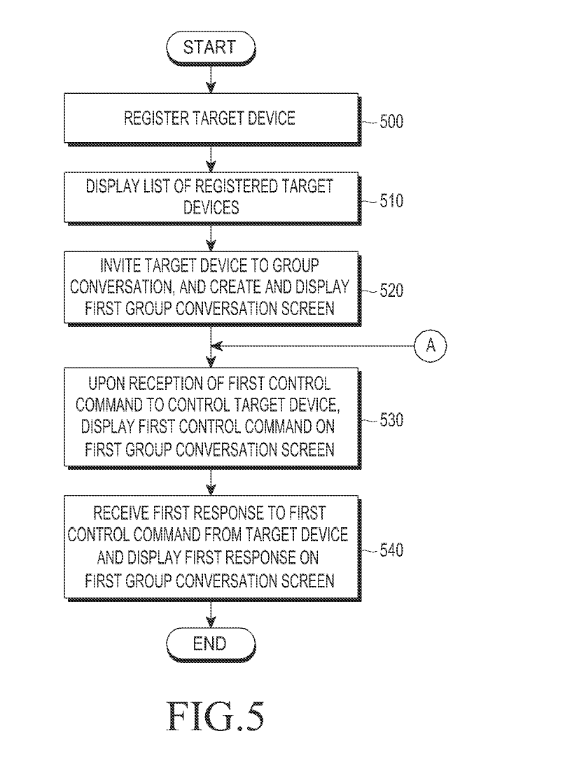

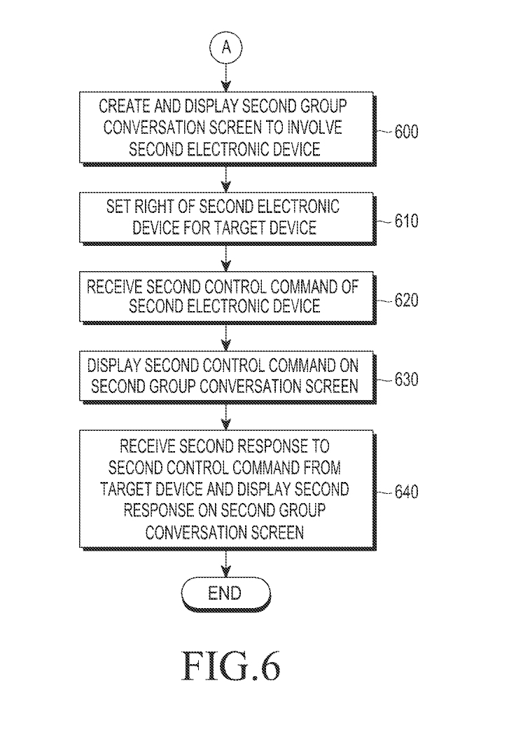

FIGS. 5 and 6 are a detailed flowchart illustrating a procedure of controlling target devices through a group conversation in the electronic device 10 according to an embodiment of the present disclosure.

Referring to FIG. 5, in operation 500, the processor 100 registers at least one target device in a conversation target list for group conversation. In other words, the processor 100 may register at least one target device by entering or automatically detecting target device information about the at least one target device.

In operation 510, the processor 100 displays the conversation target list including the registered at least one target device in the display unit 120.

In operation 520, the processor 100 may invite at least one target device by creating a first group conversation screen for group conversation with the at least one target device and displays the first group conversation screen in the display unit 120. For example, the processor 100 may select at least one target device from the conversation target list, create a group conversation screen for group conversation with the selected at least one target device, and display the group conversation screen in the display unit 120.

In operation 530, when a first control command to control at least one target device is entered through the display unit 120, the processor 100 displays the first control command on a first group conversation screen.

In operation 540, upon reception of a first response to the first control command from the at least one target device, the processor 100 displays the first response on the first group conversation screen.

After operation 520, the process may continue to operations of FIG. 6 though connection A.

Referring to FIG. 6, in operation 600, the processor 100 creates a second group conversation screen to involve a second electronic device in the group conversation and displays the second group conversation screen in the display unit 120. In this regard, the processor 100 may involve the second electronic device in the second group conversation when there is a selection of the second electronic device.

In operation 610, the processor 100 sets a control right for the involved second electronic device. For example, the processor 100 may give a limited right for the second electronic device to control functions of at least one target device joining the second group conversation.

Upon reception of a second control command to control at least one target device from the second electronic device in operation 620, the processor 100 displays the second control command on the second group conversation screen in operation 630.

In operation 640, the processor receives a second response to the second control command from the at least one target device and displays the second response on the second group conversation screen. The second response may include a result of performing the function corresponding to the second control command of the second electronic device. The result of performing the function may include information about whether performing the function was successful or failed depending on whether the second electronic device has a control right for the function of the target device.

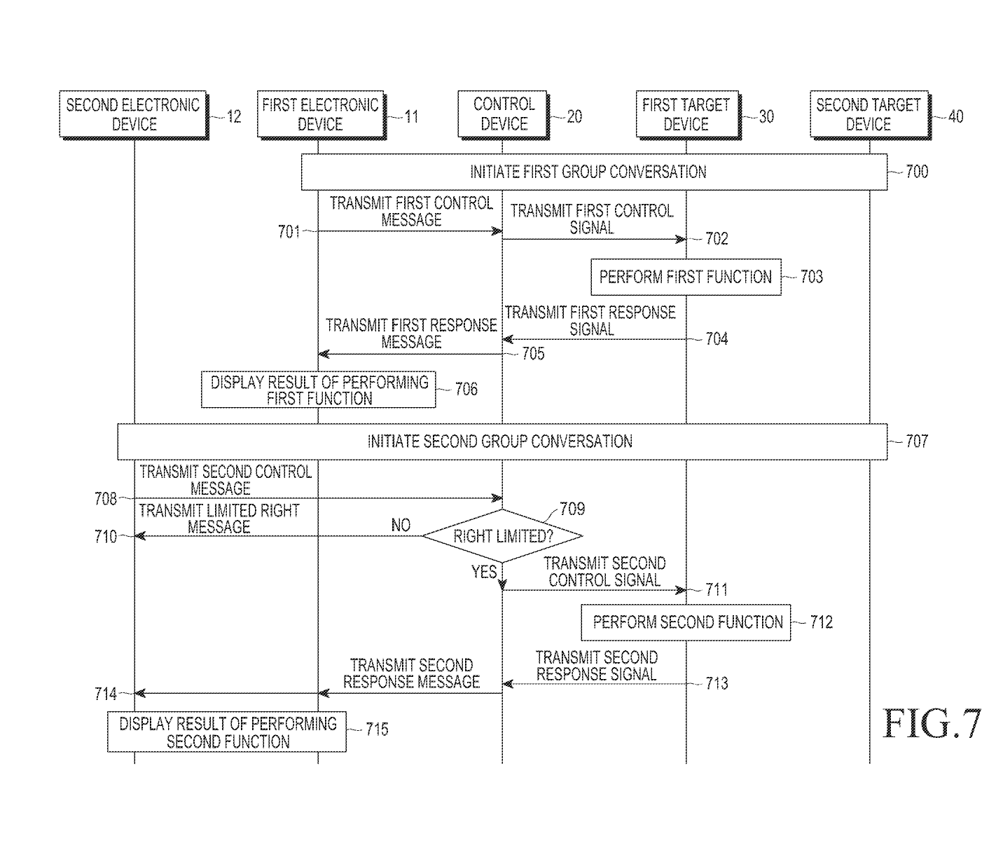

FIG. 7 is a flowchart illustrating a procedure of controlling target devices in an integrated control system according to an embodiment of the present disclosure.

Referring to FIG. 7, in this embodiment, it is assumed that the integrated control system includes a separate control device 20.

In operation 700, a first electronic device 11, the control device 20, the first target device 30, and the second target device 40 initiate first group conversation. The first electronic device 11 may create a group conversation screen for the first group conversation with the control device 20, the first target device 30, and the second target device 40.

Upon reception of a first control command to control the first target device 30, the first electronic device 11 transmits the control device 20 a first control message including the first control command, in operation 701.

Upon reception of the first control message, the control device 20 transmits the first target device 30 a first control signal based on the first control command, in operation 702.

Upon reception of the first control signal, the first target device 30 performs a first function corresponding to the first control signal, in operation 703.

The first target device 30 transmits the control device 20 a first response signal including a result of performing the first function, in operation 704.

The control device 20 transmits the first electronic device 11 a first response message including the result of performing the first function, in operation 705.

The first electronic device 11 displays the result of performing the first function included in the first response message on a group conversation screen, in operation 706.

In operation 707, the first electronic device 11, the control device 20, the first target device 30, and the second target device 40 initiate second group conversation in which a second electronic device 12 is involved.

In operation 708, the second electronic device 12 transmits the control device 20 a second control message including a second control command to control the first target device 30.

In operation 709, the control device 20 determines whether there is a right for the second electronic device 12 to control functions of the first target device 30. If determining that there is no right for the second electronic device 12 to control the function of the first target device 30, the control device 20 transmits a message indicating that there is no right for the second electronic device 12 to control the function of the first target device 30 to the second electronic device 12, in operation 710.

Otherwise, if determining that there is the right for the second electronic device 12 to control the function of the first target device 30, the control device 20 transmits the first target device 30 a second control signal based on the second control message, in operation 711.

Upon reception of the second control signal, the first target device 30 performs a second function corresponding to the second control signal, in operation 712.

The first target device 30 transmits the control device 20 a second response signal including a result of performing the second function, in operation 713.

Upon reception of the second response signal, the control device 20 transmits a second response message including the result of performing the second function to the first electronic device 11 and the second electronic device 12, in operation 714.

The first electronic device 11 and the second electronic device 12 display the result of performing the second function included in the second response message on their group conversation screens, in operation 715.

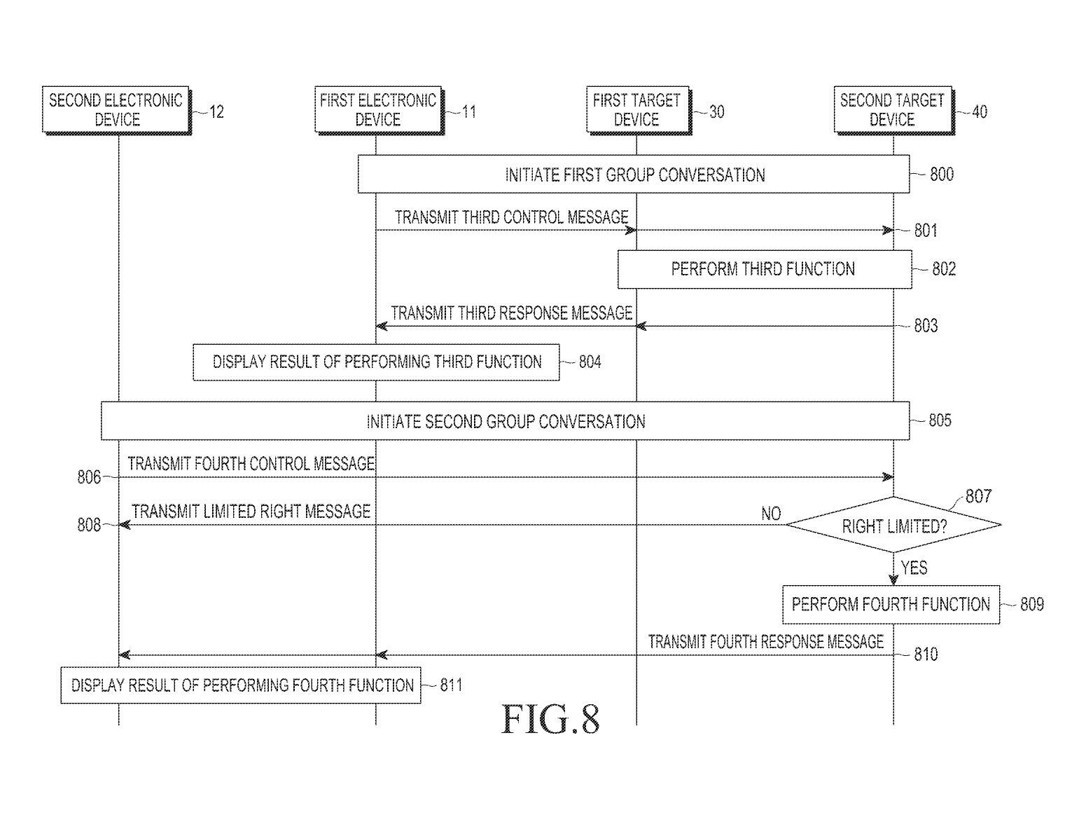

FIG. 8 is a flowchart illustrating a procedure of controlling target devices in an integrated control system according to another embodiment of the present disclosure.

In this embodiment, it is assumed that at least one target device includes its own control device.

Referring to FIG. 8, in operation 800, the first electronic device 11, the first target device 30 and the second target device 40 initiate first group conversation. The first electronic device 11 may create a group conversation screen for the first group conversation with the first target device 30 and the second target device 40.

If a third control command to control the first and second target devices 30 and 40 is entered, the first electronic device 11 transmits a third control message including the third control command to the first and second target devices 30 and 40, in operation 801.

Upon reception of the third control message, the first and second target devices 30 and 40 each perform a third function corresponding to the third control message, in operation 802. For example, the third function may be a power off function of the first and second target devices 30 and 40.

In operation 803, the first and second target devices 30 and 40 each transmit a third response message including a result of performing the third function to the first electronic device 11.

In operation 804, the first electronic device 11 displays the result of performing the third function included in the third response message on the group conversation screen.

In operation 805, the first electronic device 11, the first target device 30, and the second target device 40 initiate second group conversation in which a second electronic device 12 is involved.

In operation 806, the second electronic device 12 transmits the second target device 40 a fourth control message including a fourth control command to control the second target device 40.

In operation 807, the second target device 40 determines whether there is a right for the second electronic device 12 to control functions of the second target device 40. If determining that there is no right for the second electronic device 12 to control the function of the second target device 40, in operation 808, the second target device 40 transmits a message indicating that there is no right for the second electronic device 12 to control the function of the second target device 40 to the second electronic device 12.

Otherwise, if determining that there is the right for the second electronic device 12 to control the function of the second target device 40, in operation 809, the second target device 40 performs a fourth function corresponding to the fourth control command.

In operation 810, the second target device 40 transmits a fourth response message including a result of performing the fourth function to the first electronic device 11 and the second electronic device 12.

In operation 811, the first electronic device 11 and the second electronic device 12 display the result of performing the fourth function included in the fourth response message on their group conversation screens.

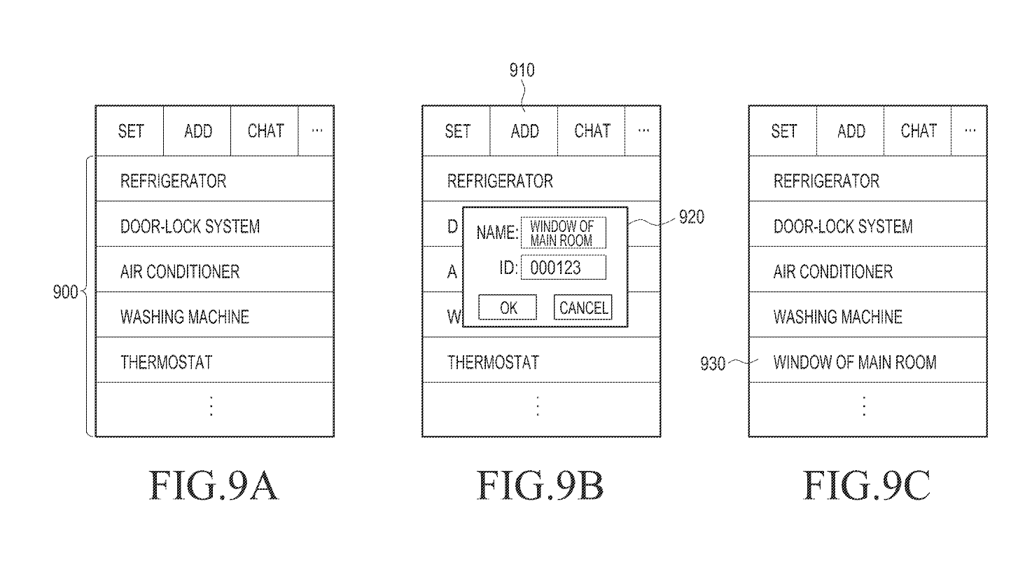

Referring to FIGS. 9A to 15, various embodiments of controlling target devices will be described. FIGS. 9A to 15 illustrate screen images of the electronic device 10, but it will be appreciated that there may be other screen images in other embodiments.

FIGS. 9A to 9C illustrate screen images showing a procedure of adding a new target device onto a target device list according to an embodiment of the present disclosure.

Referring to FIG. 9A, the processor 100 may run a social network service based application to perform group conversation to control target devices. A running screen of the application may be displayed, including a conversation target list 900 for group conversation.

Referring to FIG. 9B, if there is an input 910 to add a new target device, the processor 100 may display an input window 920 to add target device information, such as a name, an ID, and the like, of the new target device.

Referring to FIG. 9C, with the target device information, the processor 100 may add a new target device 930 like “window of a main room” onto the conversation target list.

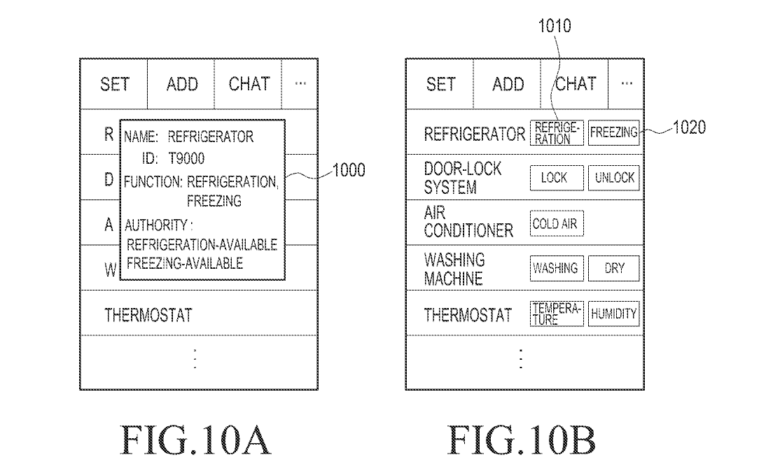

FIGS. 10A and 10B illustrate screen images of a first electronic device that initiates group conversation and displays detailed information and usable functions of target devices according to an embodiment of the present disclosure.

Referring to FIG. 10A, upon request to display detailed information about a target device, the processor 100 may display a window 1000 for displaying detailed information about the target device. The window 1000 may include a name and ID of the target device, functions that may be performed in the target device, a right of the electronic device 10 for functions of the target device, and the like. The processor 100 may also provide an edit screen (not shown) to modify, delete, and change the target device information.

Referring to FIG. 10B, alternatively, the processor 100 may display the conversation target list with functions and right indications of the target devices. For example, with the item of a refrigerator on the conversation target list, a refrigeration icon 1010 representing the refrigerating function and a freezing icon 1020 representing the freezing function may be displayed. As such, corresponding functions of target devices on the conversation target list that may be controlled by the processor 100 of the electronic device 10 may be displayed as shown in FIG. 10B.

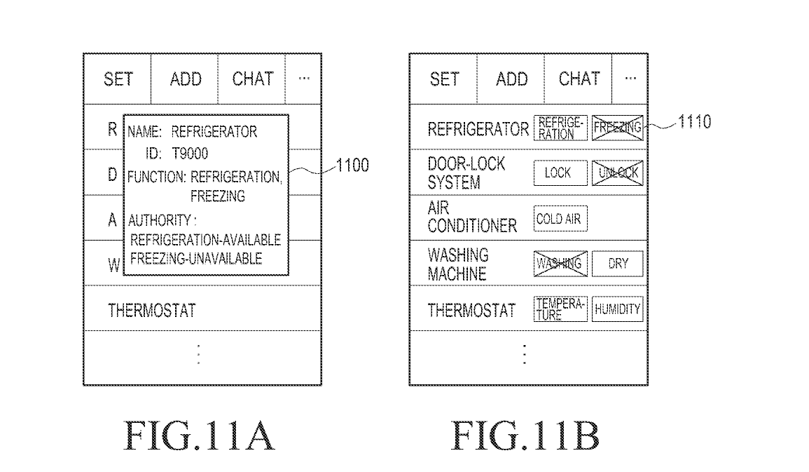

FIGS. 11A and 11B illustrate screen images of a second electronic device that participates in a group conversation and displays detailed information and usable functions of target devices according to an embodiment of the present disclosure.

Referring to FIG. 11A, the processor 100 may be able to give a limited right for the second electronic device 12 that has just joined the group conversation to control functions of the target devices. On request to display detailed information about target devices, the second electronic device 12 having the limited right for functions of the target devices may generate a window 1100 displaying detailed information about one of the target devices. The window 1100 may include a name and ID of the target device, functions to be performed in the target device, a limited right of the second electronic device 12 for the functions of the target device, and the like.

Referring to FIG. 11B, alternatively, the second electronic device 12 may display the conversation target list with functions and right indications of the target devices. For example, since the second electronic device 12 has a limited right to control functions of the target devices, there may be icons 1110 representing that corresponding functions are not controllable to the second electronic device 12.

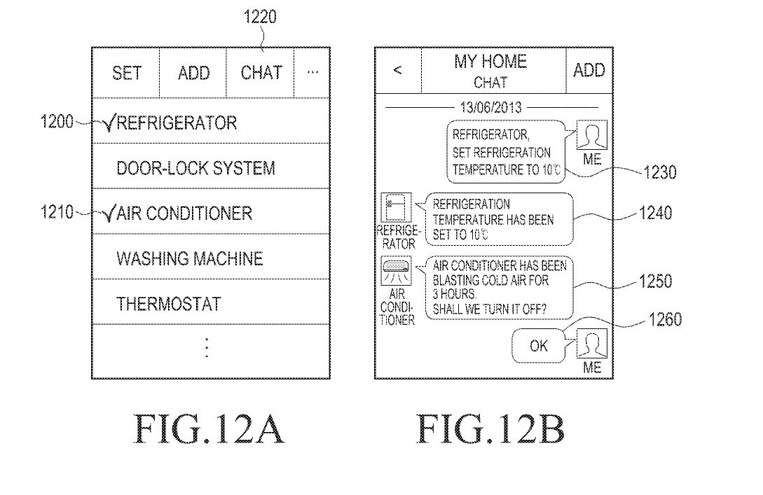

FIGS. 12A and 12B illustrate screen images showing a procedure of controlling target devices through a group conversation according to an embodiment of the present disclosure.

Referring to FIG. 12A, the processor 100 may select some target device items, e.g., refrigerator 1200 and air conditioner 1210 from a conversation target list, and may create and display a group conversation screen when conversation is requested 1220 for group conversation.

Referring to FIG. 12B, if a control command, e.g., “refrigerator, set the refrigeration temperature to 10° C.” is entered, the processor 100 may display the text “refrigerator, set the refrigeration temperature to 10° C.” 1230 on the group conversation screen.

The processor 100 may transmit the control command to the refrigerator, and upon reception of a result of performing the corresponding function from the refrigerator, may display a text in connection with the result, e.g., “refrigeration temperature has been set to 10° C.” 1240 on the group conversation screen. For example, the refrigerator may recognize words like “refrigerator”, “set”, “refrigeration temperature”, and “10° C.” from the text “refrigerator, set the refrigeration temperature to 10° C.” 1230, and accordingly set the refrigeration temperature to 10° C. In this case, although the air conditioner joining the group conversation could recognize such words, the air conditioner may not take them as a control command for itself and thus perform no activity.

In another example, upon reception of a status notification message indicating a status of the air conditioner from the air conditioner, the processor 100 may display a text, e.g., “Air conditioner has been blasting cold air for three hours. Shall we turn it off?” on the group conversation screen 1250. If a control command, e.g., “OK” is entered, the processor 100 may display the corresponding text “OK” 1260 on the group conversation screen while delivering the control command to the air conditioner. The air conditioner may perform its power off function.

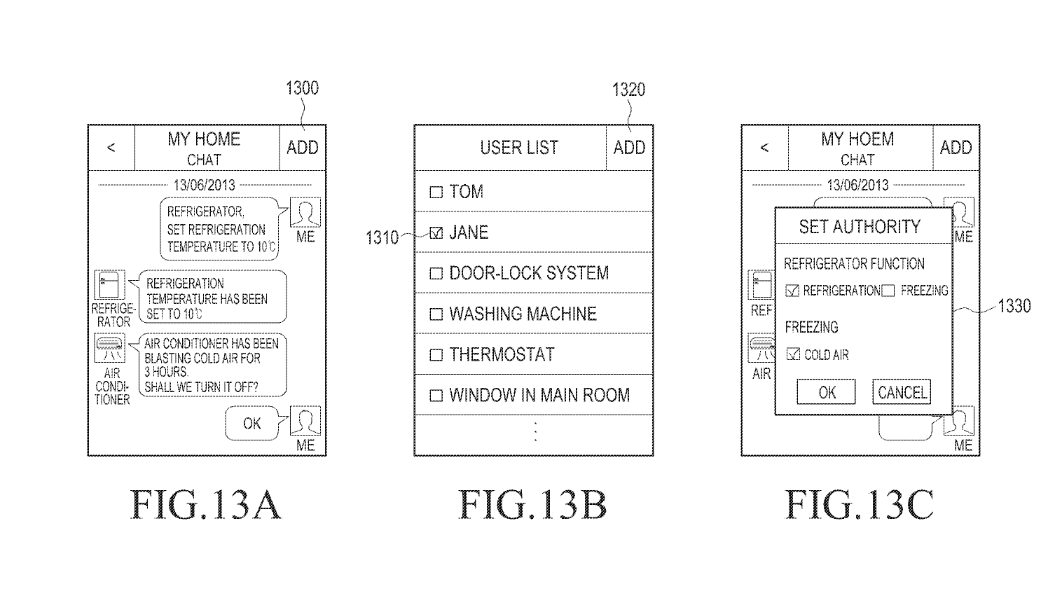

FIGS. 13A to 13C illustrate screen images showing how to add a new user into a group conversation and to set a right of the new user according to an embodiment of the present disclosure.

Referring to FIG. 13A, If there is an additional request to add a new conversation party 1300 while performing a group conversation.

Referring to FIG. 13B, the processor 100 may display a conversation target list to add the new conversation party.

For example, upon request 1320 to add Jane 1310 selected from the conversation target list to the group conversation, the processor 100 adds Jane 1310 to the group conversation.

Referring to FIG. 13C, the processor 100 may display a window 1330 to set a control right for Jane to control functions of a refrigerator and an air conditioner joining the group conversation. Through the window 1330, Jane may be given control rights for refrigeration function of the refrigerator and cold air blasting function of the air conditioner.

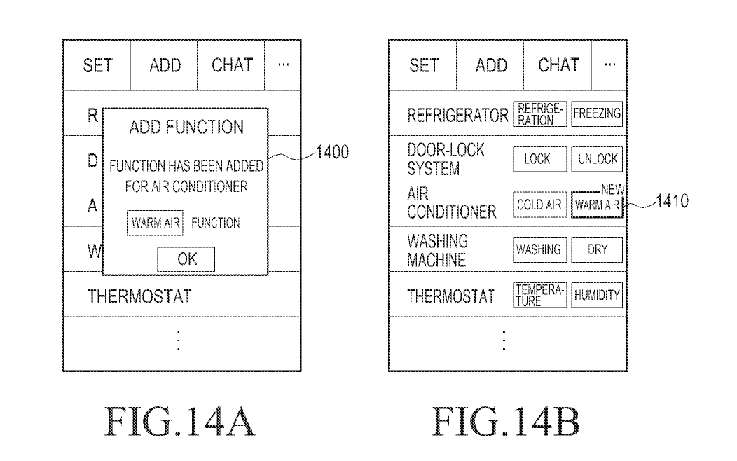

FIGS. 14A and 14B illustrate screen images showing how to add a new function of a target device according to an embodiment of the present disclosure.

Referring to FIG. 14A, If there is a target device for which a new function has been newly added, the processor 100 may add information about the target device and display a notification window 1400 about the newly added function. For example, if a warm air blasting function is added for the air conditioner, the processor 100 may receive a notification message about the added function from the air conditioner and display the notification window 1400 about the added warm air blasting function.

Referring to FIG. 14B, alternatively, the processor 100 may display an icon 1410 representing the added warm air blasting function on the conversation target list.

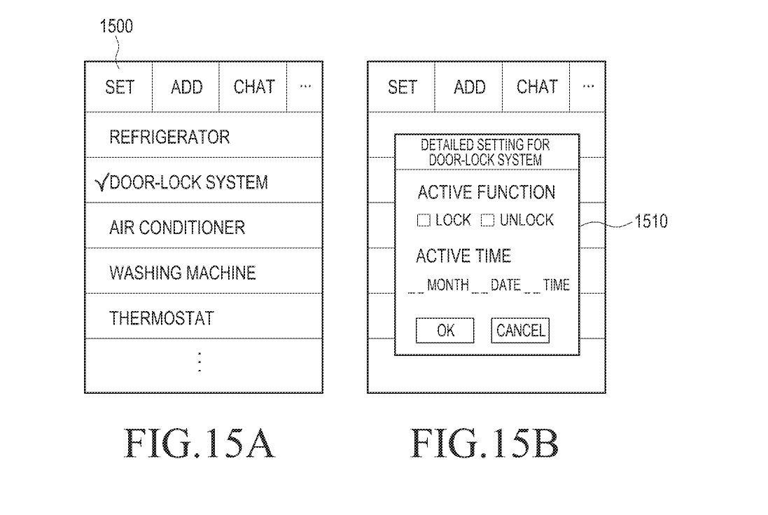

FIGS. 15A and 15B illustrate setting screens for a target device according to an embodiment of the present disclosure.

Referring to FIG. 15A, the processor 100 may set to perform a function of a target device without making a group conversation to control the target device. For example, if there is a setting request 1500 for a door-lock system.

Referring to FIG. 15B, the processor 100 may display a setting window 1510 to set door-lock functions. With the setting window 1510, the user may select desired functions from functions of the door-lock system and time to perform the selected functions, and control the selected functions to be performed at the selected time.

As such, according to the embodiments of the present disclosure, an electronic device may control functions through social network service based group conversation with at least one target device, thereby allowing the user to conveniently control the target device using such a familiar interface.

It will be appreciated that the embodiments of the present disclosure may be implemented in a form of hardware, software, or a combination of hardware and software. The software may be stored as program instructions or computer readable codes executable on the processor on a computer-readable medium. Examples of the computer readable recording medium include magnetic storage media (e.g., ROM, floppy disks, hard disks, and the like), and optical recording media (e.g., CD-ROMs, or DVDs). The computer readable recording medium can also be distributed over network coupled computer systems so that the computer readable code is stored and executed in a distributed fashion. This media can be read by the computer, stored in the memory, and executed by the processor. The various embodiments may be implemented by a computer or portable terminal including a controller and a memory, and the memory may be an example of the computer readable recording medium suitable for storing a program or programs having instructions that implement the embodiments of the present disclosure. The various embodiments may be implemented by a program having codes for embodying the apparatus and method described in claims, the program being stored in a machine (or computer) readable storage medium. The program may be electronically carried on any medium, such as communication signals transferred via wired or wireless connection, and the present disclosure suitably includes its equivalent.

The electronic device may receive the program from a program provider wired/wirelessly connected thereto, and store the program. The program provider may include a memory for storing programs having instructions to perform the embodiments of the present disclosure, information necessary for the embodiments of the present disclosure, and the like, a communication unit for wired/wirelessly communicating with the electronic device, and a controller for transmitting the program to the electronic device on request or automatically.

Several embodiments have been described in connection with e.g., mobile communication terminals, but a person of ordinary skill in the art will understand and appreciate that various modifications can be made without departing the scope of the present disclosure. Thus, it will be apparent to those ordinary skilled in the art that the disclosure is not limited to the embodiments described, which have been provided only for illustrative purposes.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a communication unit configured to communicate data; and
a processor configured to initiate a group conversation to control at least one target device, and, upon reception of a control command to control a function of the at least one target device, to transmit the control command to the at least one target device through the group conversation.

2. The electronic device of claim 1, further comprising:
a display unit,
wherein the processor is further configured to receive a result of performing the function of the at least one target device corresponding to the control command display from the at least one target device, and to display the result in the display unit.

3. The electronic device of claim 2, wherein the processor is further configured to receive target device information about a new target device to register the new target device in a conversation target list of target devices for the group conversation.

4. The electronic device of claim 3, wherein the target device information includes at least one of a name and ID of the new target device, a function that is performed in the new target device, and a control right for the function that is performed in the new target device.

5. The electronic device of claim 3, wherein the processor is further configured to select a second electronic device from the conversation target list and involve the second electronic device in the group conversation.

6. The electronic device of claim 5, wherein the processor is further configured to set a right for the second electronic device to control the function of the at least one target device.

7. The electronic device of claim 3, wherein the group conversation comprises a social network service based group conversation.

8. The electronic device of claim 2, wherein the processor is further configured to display a group conversation screen for the group conversation in the display unit; and upon reception of the control command, display the control command on the group conversation screen.

9. The electronic device of claim 8, wherein the processor is further configured to display the result received from the at least one target device on the group conversation screen.

10. A method comprising:
initiating a group conversation to control at least one target device;
receiving a control command to control a function of the at least one target device; and
transmitting the control command to the at least one target device through the group conversation.

11. The method of claim 10, further comprising:
receiving a result of performing the function corresponding to the control command from the at least one target device; and
displaying the result on a screen.

12. The method of claim 11, further comprising:
receiving target device information about a new target device to register the new target device in a conversation target list of target devices for the group conversation.

13. The method of claim 12, wherein the target device information includes at least one of a name and ID of the new target device, a function that is performed in the new target device, and a control right for the function that is performed in the new target device.

14. The method of claim 12, further comprising:
selecting a second electronic device from the conversation target list; and
involving the second electronic device in the group conversation.

15. The method of claim 14, further comprising:
setting a right for the second electronic device to control the function of the at least one target device.

16. The method of claim 12, wherein the group conversation is performed on a social network service basis.

17. The method of claim 11,
wherein initiating the group conversation comprises creating a group conversation screen for the group conversation, and
wherein receiving the control command comprises displaying the received control command on the group conversation screen.

18. The method of claim 11, wherein displaying the result on the screen comprises displaying the result received from the at least one target device on the group conversation screen.

19. The method of claim 10, further comprising:
initiating a second group conversation with the at least one target device and a second electronic device;
setting a right for the second electronic device that has joined the second group conversation;
displaying, upon reception of a second control command for the second electronic device to control the target device, the second control command on a screen; and
displaying, upon reception of a second response to the second control command from the target device, the second response on the screen.
